(19) United States
(12) Patent Application Publication
(10) Pub. No.: US 2006/0260286 A1
(43) Pub. Date: Nov. 23, 2006

(54) Spark arrestor

(75) Inventors: Rolf Schlebes, Hamminkeln (DE); Andreas Kiy, Gelsenkirchen (DE)

Correspondence Address: MERCHANT & GOULD PC, P.O. BOX 2903, MINNEAPOLIS, MN, 55402-0903, US

(73) Assignee: Donaldson Company, Inc., Minneapolis, MN (US)

(21) Appl. No.: 10/530,791

(22) PCT Filed: Oct. 8, 2003
(86) PCT No.: PCT/IB03/06510

§ 371 Date: Mar. 30, 2006

(30) Foreign Application Priority Data
Oct. 8, 2002 (DE) 20215433.5

(51) Int. Cl. B01D 46/00

(52) U.S. Cl. 55/523

(57) ABSTRACT

A device for removing sparks or other hot particles from a gaseous stream comprises a housing (10) with an inlet (12) and an outlet (14) for the gaseous stream and means for removing the sparks or other particles. A bulk ceramic or mineral material is provided inside the housing in an inlet region facing the inlet (partition 20) and in an outlet region facing the outlet (partition 22). The bulk material is arranged in the housing in such a way that the entire gaseous stream is forcibly guided through the bulk material. The path followed by the gaseous stream through the bulk material is determined in such a way, depending on the type and grain size of the material, that the gaseous stream is substantially free from sparks after the outlet region.

The invention relates to a device for removing sparks or other hot particles from a gaseous stream. The device comprises a housing with an inlet and an outlet for the gaseous stream and means for removing the sparks or other particles.

Devices of this kind are known and are used in conjunction with air purification equipment in industrial settings in order, during polishing or welding of metals, for example, to reduce the energy content of dust and other particles with high thermal energy, particularly sparks, and in the process to extinguish such sparks.

The air, which may be contaminated in this way during polishing or welding, for example, is usually extracted in industrial applications and fed to air purification equipment fitted with appropriate filters. These filters generally contain filter elements, filter bags, filter pouches or filter cartridges in which natural fibers or plastics are used, and in which the filter material can be held in place with plastic The purpose of using the devices referred to at the outset as prescreeners or prefilters for air purification filters is to prevent highly energized dust particles from burning holes in the filter material or indeed from setting it on fire.

Until now, devices with baffle plates or cyclones have been used for such purposes, with the extracted gaseous stream passing through such devices. They served their purpose more or less satisfactorily, but not always with the degree of safety that is necessary in many cases, and were also costly.

The object of the invention was therefore to propose a device of the kind initially specified that achieves better results than the prior art with regard to the removal of energy and particularly, therefore, to the extinguishing of sparks.

On the basis of the device initially referred to for removing sparks or other hot particles from a gaseous stream, comprising a housing with an inlet and an outlet for the gaseous stream and means for removing the sparks or other particles, the solution for this technical problem according to the invention consists in a bulk ceramic or mineral material being provided inside the housing in an inlet region facing the inlet and in an outlet region facing the outlet, and in the bulk material being arranged inside the housing in such a way that the entire gaseous stream is forcibly guided through the bulk material, and the path followed by the gaseous stream through the bulk material being determined in such a way, depending on the type and grain size of the material, that the gaseous stream is substantially free from sparks after the outlet region.

In this way, the technical problem posed is solved.

It is preferred in this solution to the problem that the material is caught between two perforated, spaced-apart partitions, whereby it is advantageous if the space between the partitions of the device according to claim 2 is characterized in that said space has at least one closeable opening for filling and emptying the space.

In order to be able to replace the bulk material after an extended period of operation, openings may be provided on the housing through which it can be filled and emptied, and which connect the aforesaid cavity between the partitions with the surroundings if so required.

It is conducive for practical operation if the housing has at least one and preferably two inlets for feeding compressed air into the interior of the housing for cleaning purposes, in addition to at least one and preferably a plurality of water inlets so that water or some other coolant can be injected into the housing in exceptional cases in order to reduce temperatures or even to extinguish fire or sparks. Said inlets open, in the direction of flow, into the interior of the housing upstream or downstream from the space between the partitions.

The material used as bulk material has a microporous surface, and it is particularly preferred that it consist of expanded clay. One advantage of this material is that it is highly hygroscopic. This property prevents undesired moistening of the filter material in the downstream main filter unit when water is injected through the aforementioned nozzles to lower the energy of the gas or to extinguish a fire.

Tests with the device according to the invention have shown that good results can be achieved with material that has a grain size of approximately 5 to 15 mm. With regard to the thickness of the bulk material in the direction of flow, it has been found that the duration of contact between the gas and the material should be kept between about 0.1 and 2 seconds. According to experience gained to date, the thickness determined in such tests is sufficient to solve the technical problem of the invention without the drop in pressure between the inlet and the outlet of the device becoming undesirably great.

When expanded clay is used, the device according to the invention can also be used to great advantage to dry waste air or exhaust gas, for example during the start-up phase of various processes.

The invention shall now be described in greater detail with reference to the two embodiments shown in the drawings. The drawings show:

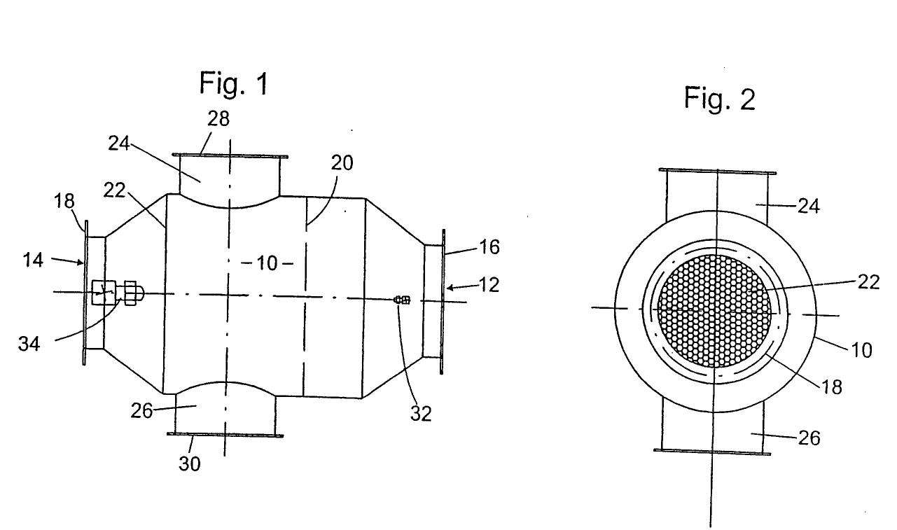

FIG. 1 a side elevation view of a device according to the invention;

FIG. 2 a front elevation view of the left side of the device shown in FIG. 1;

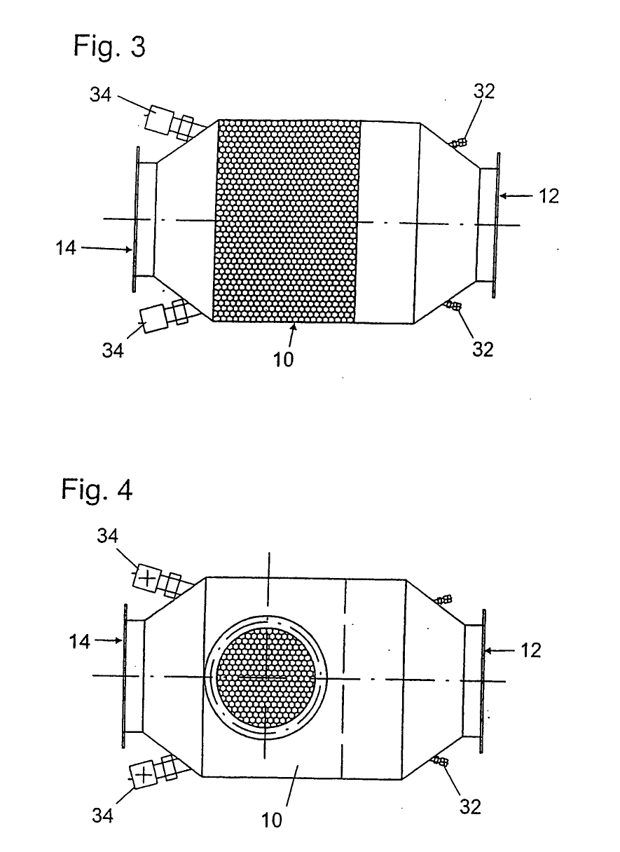

FIG. 3 a longitudinal cross-section of the device in FIG. 1;

FIG. 4 a plan view of the top side of the device in FIG. 1;

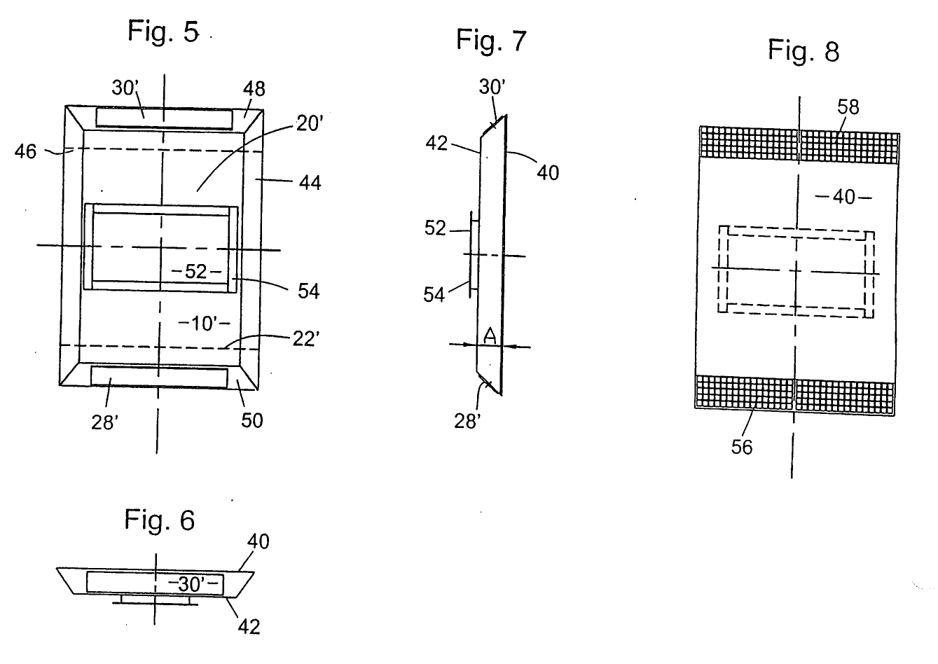

FIG. 5 a view of a design variant of the invention in the form of a device that joins onto a main filter unit;

FIG. 6 a plan view of the device in FIG. 5,

FIG. 7 a side elevation view of the device in FIG. 5 and

FIG. 8 a rear view of the device.

The first embodiment of the invention pursuant to FIGS. 1 to 4 has a substantially cylindrical housing 10 with an inlet 12 and an outlet 14. The inlet and outlet are fitted with flanges 16, 18, with the aid of which the housing 10 can be incorporated into a pipeline (not shown) through which a contaminated gas, usually contaminated air carrying sparks, flows to a main filter unit (not shown). The housing widens in the region adjacent to inlet 12 and has a subsequent cylindrical portion in the direction of flow, before tapering again in a cone-shaped portion before joining outlet 14.

Inside housing 10, two spaced-apart perforated metal plates defining the interior of the housing in its cylindrical portion and disposed at approximately 90 degrees to the direction of flow are installed as partitions 20, 22 and fixedly attached to the housing. Said two partitions 20, 22 delineate a cylindrical cavity inside housing 10. The length of said cavity, as measured in the direction of gas flow, may differ depending on the specific application, as will be discussed further below.

The housing 10 also has two opposite connection pieces 24, 26 that each have an opening at their free ends that can be closed with covers 28, 30. The cavity in housing 10 defined by partitions 20, 22 is filled with a bulk ceramic or mineral material through one of said connection pieces. The purpose of the other connection piece is to empty said cavity in housing 10 when so required.

Adjacent to inlet 12 of housing 10, the housing is fitted with one or more compressed air inlets 32 through which compressed air can be blown into the interior of housing 10 for cleaning purposes, in order to extend the service life of the device.

At the end portion of the housing facing outlet 14, the housing is fitted with one or more injection nozzles for a coolant, in particular water. By injecting water into the housing, the temperatures of the gaseous stream can be lowered, and any unexpected fires can be extinguished.

The device pursuant to FIGS. 1 to 4 can be installed in any position, in particular in a vertical or horizontal position, within existing waste air or exhaust gas conduits. It is self-evident that housing 10 cascades with one or more such housings, i.e., that it can be installed in horizontal or vertical series within an exhaust gas conduit.

The material used for the bulk filling is a porous granulate. One material particularly suitable for the purposes of the invention is expanded clay, which is a highly heat-resistant, fired and microporous material. In certain cases, it is also possible to use gravel. Both types of material, i.e. a ceramic or mineral material in the form of a preferably microporous granulate, cause the gas flowing through inlet 12 to be deflected many times during a preferred retention time of preferably 0.1 and 2 seconds by the material in the region between the two perforated metal plates, whereupon the gas loses as much energy as is required for the purpose intended here, as a result of which, in particular, any sparks in the gaseous stream are extinguished.

Another possible embodiment is shown in FIGS. 5 to 8, which will now be discussed in brief.

The variant shown here of a prefilter according to the invention is shaped in such a way as to permit said prefilter to be flanged directly onto a main filter unit.

The prefilter in this second embodiment has a plane rear wall 40 serving as a connection to the main filter unit, which is not shown in the Figure. At a spacing A (FIG. 7) from said rear wall 40, there is a front wall 42 of somewhat smaller dimensions running parallel to the rear wall. Oblique side walls 44, 46, 48, 50 connect the rear wall to the front wall to form a housing 10′.

The opposite side walls 44 and 46 have openings analogous to connection pieces 24, 26; said openings can be closed with the aid of covers 28′, 30′ and can be used to fill the bulk material into the prefilter or to remove it therefrom.

The front wall 42 has an inlet opening 52, which in the embodiment shown is square in shape, said inlet opening being delineated by a flange 54, and the inflowing gas flows through said inlet opening into housing 10′, The pipeline required is not shown in the drawing.

Inside housing 10′, there are two partitions 20′, 22′ in the form of perforated metal plates, shown by two broken lines; said perforated plates connect the rear wall 40 with the front wall 42 between side walls 44, 46, thus forming pockets for the ceramic or mineral material, said pockets being accessible through the upper and lower covers 28′, 30′.

In FIG. 8, which shows the rear side of the device in this embodiment, one can see two additional perforated metal plates 56, 58 that each close a square opening in the upper or lower end of the rear wall 40 (as seen in the drawing) such that gas can still pass through, thus causing the ceramic or mineral material to be retained inside housing 10.

Inside housing 10, the gas flowing in through opening 52 firstly encounters rear wall 40, where it is deflected 90 degrees upwards or downwards before flowing through partition 20′ or 22′ comprised of a perforated metal plate, then being deflected many times by the granulate inside, before finally leaving housing 10 through the perforated metal plates 56, 58, from whence the gas flows directly and without intervening piping into the main filter unit 15.

1. A device for removing sparks or other hot particles from a gaseous stream comprises a housing (10) with an inlet (12) and an outlet (14) for the gaseous stream and means for removing the sparks or other particles.
wherein a bulk ceramic or mineral material is provided inside the housing in an inlet region facing the inlet (partition 20) and in an outlet region facing the outlet (partition 22), that the bulk material is arranged in the housing in such a way that the entire gaseous stream is forcibly guided through the bulk material,
and that the path followed by the gaseous stream through the bulk material is determined in such a way, depending on the type and grain size of the material, that the gaseous stream is substantially free from sparks after the outlet region.

2. Device according to claim 1,
wherein the material inside the housing is caught between two perforated, spaced-apart partitions (20, 22).

3. Device according to claim 2,
wherein the space between the partitions (20, 22) has at least one closeable opening (openings 24, 26) for filling and emptying the space.

4. Device according to claim 3,
wherein one closeable opening for filling and one closeable evacuation opening are provided.

5. Device according to claim 1, wherein the housing has at least one compressed air inlet (32) for cleaning purposes.

6. Device according to claim 1, wherein the housing has at least one water inlet.

7. Device according to claim 5 wherein the inlets open in the direction of flow into the housing (10) upstream or downstream from the space between the partitions.

8. Device according to claim 1, wherein the material has a microporous surface.

9. Device according to claim 1, wherein the material is expanded clay.

10. Device according to claim 1, wherein the material is gravel.

11. Device according to claim 1, wherein the material has a grain size of approximately 5-15 mm.

12. Device according to claim 1, wherein the thickness of the bulk material in the direction of flow is defined such that the duration of contact between the gas and the material is between about 0.1 and 2 seconds.
